(19) United States
(12) Patent Application Publication
(10) Pub. No.: US 2007/0233449 A1
(43) Pub. Date: Oct. 4, 2007

(54) Simulation of hierarchical storage systems

(75) Inventors: Glenn R. Peterson, Kenmore, WA (US); John M. Oslake, Seattle, WA (US); Pavel A. Dournov, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/394,473

(22) Filed: Mar. 31, 2006

(51) Int. Cl. G06F 13/10

(52) U.S. Cl. 703/20

(57) ABSTRACT

Modeling storage devices. One or more data structures define one or more storage devices including empirical characterizations or other characteristics of storage device operations for the specific storage devices. The empirical characterization are obtained as a result of laboratory testing of one or more sample components of the specific storage devices, or storage device similar to the specific storage devices. Complex storage device models that include disk arrays and storage networks can be represented as combinations of element models I/O operations are simulated by applying data structures that represent storage device operations to the one or more data structures. A latency is calculated based on the application of models of I/O operations as storage device operations. The latency may include portions calculated from empirical testing data as well as portions calculated from analytical modeling information.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Computer systems can be interconnected in large network configurations so as to provide additional functionality. For example, one typical network configuration is a configuration of computer systems interconnected to perform e-mail functionality. In one particular example, an e-mail server acts as a central location where users can send and retrieve emails. For example, a user may send an e-mail to the e-mail server with instructions to the e-mail server to deliver the message to another user connected to the e-mail server. Users can also connect to the e-mail server to retrieve messages that have been sent to them. Many e-mail-servers are integrated into larger frameworks to provide functionality for performing scheduling, notes, tasks, and other activities.

Each of the computer systems within a network environment has certain hardware limitations. For example, network cards that are used to communicate between computer systems have a limited amount of bandwidth meaning that communications can only take place at or below a predetermined threshold rate. Computer processors can only process a given amount of instructions in a given time period. Hard disk drives are limited in the amount of data that can be stored on the disk drive as well as limited in the speed at which the hard disk drives can store the data.

When creating a network that includes a number of different computer systems it may be desirable to evaluate the selected computer systems before they are actually implemented in the network environment. By evaluating the systems prior to actually implementing them in the network environment, trouble spots can be identified and corrected. This can result in a substantial cost savings as systems that unduly impede performance can be upgraded or can be excluded from a network configuration.

Two particular modeling scenarios have found widespread use in modeling storage systems. The first modeling scenario is an analytic model. The analytic model uses information such as rotational speed of a hard drive, seek time of the hard drive, transfer rate of the hard drive, and so forth to calculate the performance of a hard drive when used with a particular application. The disadvantage to this type of modeling relates to inaccuracies that result. These inaccuracies, for one reason, may exist because different manufacturers use proprietary data handling algorithms that are not accounted for in the analytic models.

The second modeling scenario is an empirical model based on benchmark data. However, empirical models typically are for a particular application and as such testing is performed for each different application. Additionally, for a given application, a particular storage configuration is assumed. Thus, the testing is also performed with each of the expected storage configurations used. In summary, if changes in an application or storage configuration are made, then new testing must be performed.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a computer readable medium. The computer readable medium may be usable in a computing system configured to simulate interactions with one or more storage devices. The computer readable medium includes a first data structure defining a storage device including an empirical characterization of storage device operations for the specific storage device. The empirical characterization may have been obtained as a result of laboratory testing of one or more sample components of the specific storage device or storage device similar to the specific storage device. The computer readable medium further includes computer executable instruction configured to apply models of I/O operations as storage device operations to the first data structure and to calculate a latency based on the application of the models of I/O operations as storage device operations. The calculated latency may also include other factors evaluated analytically such as queuing effects and other effects due to resource sharing.

Another embodiment described herein includes a computer readable medium. The computer readable medium may be usable in a computing system configured to simulate interactions with one or more storage devices. The computer readable medium includes a first data structure, defining a storage device including an empirical characterization of storage device operations for the specific storage device. The empirical characterization may have been obtained as a result of laboratory testing of one or more sample components of the specific storage device, or storage device similar to the specific storage device. The first data structure includes a hierarchical data structure defining a composite storage device. The hierarchical data structure including a number of instances of a definition of parameters for a component of the storage device instantiated together.

Another embodiment includes a method of simulating a storage device to obtain latencies. The method may be performed in a computing system configured to simulate interactions with one or more storage devices. The method includes referencing one or more data structures. The one or more data structures define one or more storage devices including empirical characterizations of storage device operations for the specific storage devices. The empirical characterization are obtained as a result of laboratory testing of one or more sample components of the specific storage devices, or storage device similar to the specific storage devices. The method further includes applying models of I/O operations as storage device operations to the one or more data structures. A latency is calculated based on the application of the models of I/O operations as storage device operations. The calculated latency may take into account the latency defined by empirical testing as well as other latency effects such as latencies due to contention for shared resources during concurrent I/O operations. If concurrent I/O operations can only be processed in serial, then the model may contain an I/O queue. If concurrent I/O operations can be processed in parallel, then the model may evaluate I/O operations simultaneously and increase all I/O latencies according to an analytic procedure.

This Summary is provided to introduce a selection of concepts sin a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings

FIG. 1 illustrates a number of hierarchical storage models;

FIG. 2 illustrates test results for a random read performed at different I/O sizes;

FIG. 3 illustrates a disk surface, head, and latency differences for random and sequential operations;

FIG. 4 illustrates mapping I/O actions to device models using subservice mapping;

FIG. 5 illustrates workload generation for creating I/O actions to be simulated by a disk model;

FIG. 6 illustrate a flow diagram for simulating a disk array;

FIG. 7 illustrates an edge labeled directed graph illustrating parallel device actions;

FIG. 8 illustrates a flow diagram for simulating a SAN; and

FIG. 9 illustrates a method of simulating latencies for storage devices.

### DETAILED DESCRIPTION

Embodiments herein may comprise a special purpose or general-purpose computer including various computer hardware, as discussed in greater detail below.

One embodiment described herein allows for the creation of hierarchical descriptions of storage devices. In particular, laboratory tests may be performed for particular operations on a storage device component. These laboratory tests can provide data to create a model for the storage device component. This model can be used to hierarchically create larger storage device models. For example, testing may be done on a single hard disk drive to determine latency for operations such as random reads, random writes, sequential reads, and sequential writes. Using the testing results, as well as analytic data to model delays attributable to data queuing, interconnects or other effect, a model can be created and evaluated for the particular hard drive. Using the models for the hard drive, a disk group model, such as a model for a Redundant Array of Independent Disks (RAID) array, may be created with the hard drive model as a component of the disk group model. Additionally, disk array models can be created using the disk group model. Further, Storage Area Network (SAN) models can be created from the disk array models. These examples illustrate how higher level complex models may be created from empirical data gathered from testing lower level actual components.

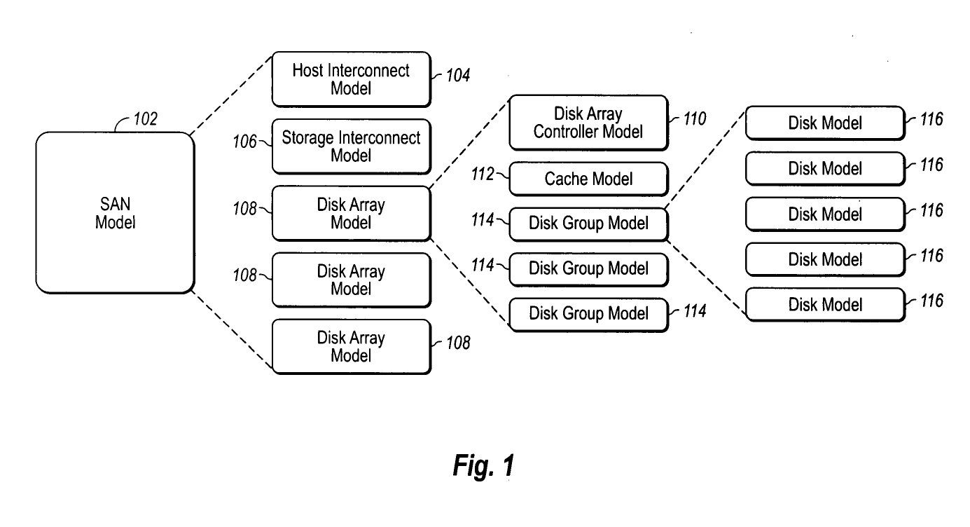

For example, and referring to FIG. 1 a hierarchical modeling structure is illustrated. In the example shown in FIG. 1 a SAN model 102 is shown. The SAN model 102 includes models such as a host interconnect model 104, a storage interconnect model 106 and disk array models 108. The disk array models 108 include a disk array controller model 110, a cache model 112, and disk group models 114. The disk group models 114 include disk models 116. In this example, empirical testing may have been performed on one or more samples of the specific disk modeled by the disk model 116, or storage devices similar to the specific disk represented in the disk model 116 As described previously testing may be performed such as by performing I/O operations on the disk to gather information about the latencies of the disk represented by the disk model 116. Notably, empirical testing may be done at any level including at the surface and disk head level of a storage device.

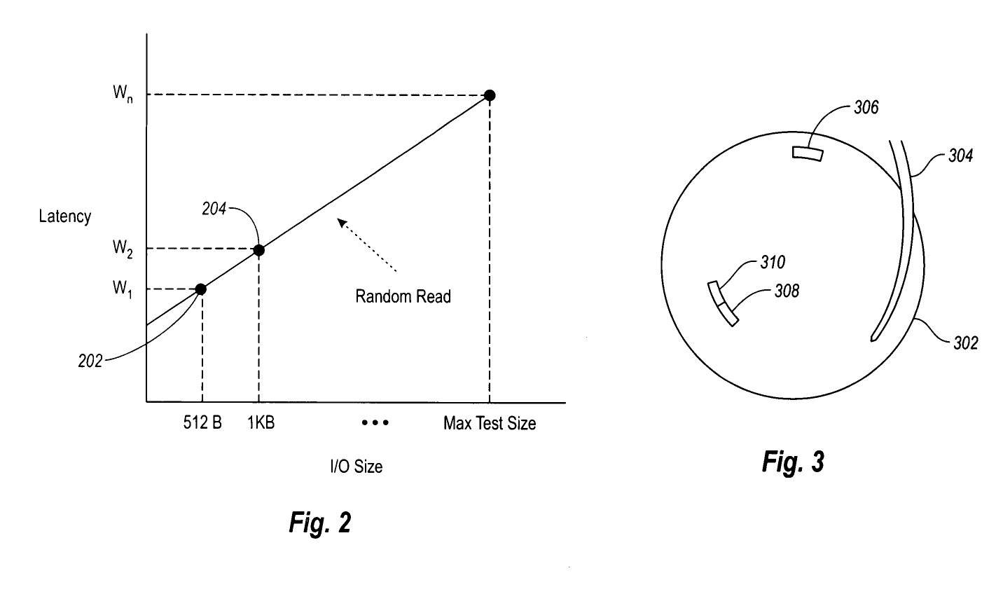

Various read and write operations may be performed on the disk represented by the disk model 116 to gather information about how the disk responds to data operations. Reference is now directed to FIG. 2 which illustrates a graph that has been created by empirical testing of a storage component such as a single disk drive. In the graph shown in FIG. 2, a random read operation is illustrated. A random read operation is one in which the disk head and or disk surface need to be repositioned to read data from the disk head. Reference is now made to FIG. 3 which shows a disk surface 302 and a disk head 304. The disk surface 302 includes three clusters of data 306, 308, and 310. The first cluster of data 306 is located on a different portion of the disks surface 302 than the second cluster of data 308. If the first data cluster 306 is read immediately before reading the second cluster of data 308, the read on the second cluster of data 308 will be a random read because of the need to significantly reposition the disk surface 302 and the disk head 304. Notably, FIG. 3 further illustrates a third data cluster 310 that is physically adjacent on the disk surface 302 to the second cluster of data 308. If the third cluster of data 310 is read after the second cluster of data 308, reading the third cluster of data is a sequential read operation. As can be appreciated, random disk operations may have higher latencies as the disk head 304 and disk surface 302 must be significantly repositioned before reading or writing can occur.

Returning once again to the description of FIG. 2, two workload operations are performed to characterize the random read latency of a particular disk drive. The first workload operation 202 is a random read operation of 512 bytes. The second workload operation 204 is a random read operation that reads 1 KB. Various tests can be performed to determine the actual latencies of these two operations. Typically, the latency of I/O operations is approximately linear with respect to their size when the disk device is operating at less than maximum I/O capacity. Therefore, once at least two data points have been obtained for the latency of an I/O operation a linear expression can be used to define the latency for nearly any size I/O operation in the absence of queuing. For example, in the present example, the latency of the I/O operation may be expressed as C+Slope×Operation Size. In this example C is a constant for the particular operation. Additionally, the slope is a slope particular to the particular operation. Note that when the disk device is operating in a neighborhood of maximum I/O capacity, I/O queuing begins to contribute significantly to the latency. I/O queuing is a performance effect that is modeled during simulation run-time, and therefore is not necessarily parameterized within the context of the disk configuration described next.

In one embodiment, a model of a disk drive will include eight parameters including a constant and slope for random reads, a constant and slope for random writes, a constant and slope for sequential reads, and a constant and slope for sequential writes. In one embodiment, the parameters may be included in the device model by including in the device model configuration information in a markup document such as an XML mark-up document. A configuration schema may specify any applicable property restrictions and provide a verification method where the validity of a property value depends on values of other properties. For example, the admissible RAID level of a disk group depends on the number of disks in the group. The configuration schema may also provide a method to compute storage capacity by accumulating storage capacities for inner configurations within a hierarchy. The following is an example of a single disk configuration:

<DeviceConfiguration
Type=“Microsoft.CapacityManager.Modeling.DeviceModels.DiskSimulationMode”>

<!--

Manufacturer: Hewlett-Packard
Model: BF036863B9

-->
<Property Name=“Guid” Value=“09AD9CB0-BBD5-4204-8ABF-894A103A83D7”/>
<Property Name=“Name” Value=“SCSI 320, 15K RPM, 36 GB” />
<Property Name=“StorageSize” Value=“36400000000” />
<Property Name=“InterfaceType” Value=“SCSI” />
<Property Name=“SeekTime” Value=“0.0038” />
<Property Name=“RotationalSpeed” Value=“250” />
<Property Name=“ExternalTransferRate” Value=“320000000” />
<Property Name=“InternalTransferRate” Value=“762000000” />
<Property Name=“ControllerCacheSize” Value=“8388608” />
<Property Name=“RandomReadLatencyConstant” Value=“4.062E-03” />
<Property Name=“RandomReadLatencySlope” Value=“2.618E-08” />
<Property Name=“RandomWriteLatencyConstant” Value=“4.596E-03” />
<Property Name=“RandomWriteLatencySlope” Value=“1.531E-08” />
<Property Name=“SequentialReadLatencyConstant” Value=“1.328E-04” />
<Property Name=“SequentialReadLatencySlope” Value=“9.453E-09” />
<Property Name=“SequentialWriteLatencyConstant” Value=“2.531E-03” />
<Property Name=“SequentialWriteLatencySlope” Value=“1.521E-08” />

</DeviceConfiguration>

In the example above, several parameters are specified including the type of device, the storage size, the interface type, the seek time, the rotational speed, the external transfer rate, the internal transfer rate, the controller cache size, and the various constants and slopes described previously.

Referring once again to FIG. 1, it should be noted that models of storage components can be included as part of other models. In particular, a composite storage device can be modeled by using a hierarchical data structure including a number of instances of definitions of parameters for a component of the composite storage device instantiated together. For example, disk group model 114 may include disk models 116. Illustratively, the following is an XML document that illustrates one example of the single disk configuration described above being implemented in a disk group configuration:

<DeviceConfiguration
Type=“Microsoft.CapacityManager.Modeling.DeviceModels.DiskGroupSimulation
Model”>

<Property Name=“Guid” Value=“884ECD92-9690-4253-908A-A1E6640E7EDB”/>
<Property Name=“Name” Value=“4-disk 15K RPM RAID-10” />
<Property Name=“RAIDLevel” Value=“10” />
<Property Name=“StripeUnitSize” Value=“65536” />
<InnerConfigurations>

<InnerConfiguration Configuration=“09AD9CB0-BBD5-4204-8ABF-

894A103A83D7”/>

<InnerConfiguration Configuration=“09AD9CB0-BBD5-4204-8ABF-

894A103A83D7”/>

<InnerConfiguration Configuration=“09AD9CB0-BBD5-4204-8ABF-

894A103A83D7”/>

<InnerConfiguration Configuration=“09AD9CB0-BBD5-4204-8ABF-

894A103A83D7”/>

</InnerConfigurations>

</DeviceConfiguration>

In this example of a disk group configuration, the disk group model includes four instances of the single disk configuration described previously. Illustratively, the references to <Innerconfiguration Configuration=“09AD9CB0-BBD5-4204-8ABF-894A103A83D7”/> include the single disk configuration by reference. Additionally, a disk array configuration may include the disk group configuration by reference in a manner similar to the inclusion of the single disk in the disk group configuration. For example, the following is an example of a disk array configuration:

<DeviceConfiguration
Type=“Microsoft.CapacityManager.Modeling.DeviceModels.DiskArraySimulation
Model”>

<Property Name=“Guid” Value=“D643A8BB-5A65-4555-BB91-1029A266CBBB”/>
<Property Name=“Name” Value=“2x 4-disk 15K RPM RAID-10/>
<Property Name=“CacheSize” Value=“4294967296” />
<Property Name=“Bandwidth” Value=“1363148800” />
<InnerConfigurations>

<InnerConfiguration Configuration=“884ECD92-9690-4253-908A-

A1E6640E7EDB”/>

<InnerConfiguration Configuration=“884ECD92-9690-4253-908A-

A1E6640E7EDB”/>

</InnerConfigurations>

</DeviceConfiguration>

In this example, the disk array configuration includes a reference to the disk group model as <InnerConfiguration Configuration=“884ECD92-9690-4253-908A-A1E6640E7EDB”/>. Notably, two instances of the disk group-model are included in the disk array model. At the root of a storage device model, such as a SAN model, a disk array model, a disk group model, and/or a disk model, exists emperical data including the constants and slopes describing I/O operation latency times attributable to the individual disks in the absence of queuing. When any device model in the storage configuration hierarchy is simulated other latencies attributable to resource sharing such as queuing effects, device interconnects and other latencies can be calculated.

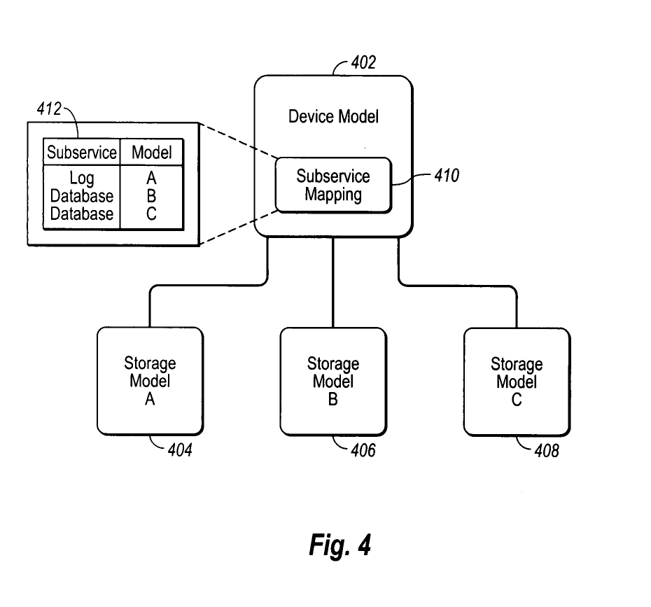

Referring now to FIG. 4, several storage models are illustrated with a device model 402. As shown storage model A 404, storage model B 406, and storage model C 408 can be connected in a modeling configuration to the device model 402. The device model 402 may be a model of some other computer hardware that produces I/O operations that will be directed to one or more of the storage models 404, 406, and 408. The connections from device model 402 to storage models 404, 406, and 408 may be logical by defining a logical mapping, and/or physical such as by defining a network interconnection.

When a simulation of the storage models is performed, various models of I/O operations are directed to storage models. Which models of I/O operations are directed to which storage model may be determined by subservice mapping that is part of the device model 402. The subservice mapping 410 may be a mapping of file types (and therfore types of models of I/O operations) to storage models. For example, the subservice mapping 410 includes a table 412 which maps files of a database application to storage models. In the example shown, log operations are mapped to storage model A 404. Database operations are mapped to storage model B 406. Database operations are also mapped to storage model C 408. This may be done to simulate optimizations that are often performed so as to more effectively utilize storage devices. For example, log operations are typically sequential in nature while database operations are typically random in nature. By separating the log operations from the database operations the efficiency advantages from performing sequential operations can more readily be realized. Subservices mapping 410 allows for modeling real world optimizations, such as for accomplishing performance optimizations, reliability optimizations, security optimizations, manageability optimizations, and the like, that may be implemented when modeling storage devices. While in the example shown in FIG. 4, each class of operations is mapped to a specific storage model, it should be noted that in other examples some operations may be mapped to the same storage model. For example, log operations and database operations could be mapped to storage model A 404. As will be described in further detail herein below, this may affect the performance of a storage device and is thus taken into account by performing operation transformations as described below Additionally, as noted above, a single database subservice may be mapped to both storage model B 406 and storage model C 408. In this case, when database models of I/O operations are provided to the storage models B and C 406 and 408, they may be provided to the storage models in a round robin fashion or in a load balancing fashion based on the disk queue depth or disk utilization.

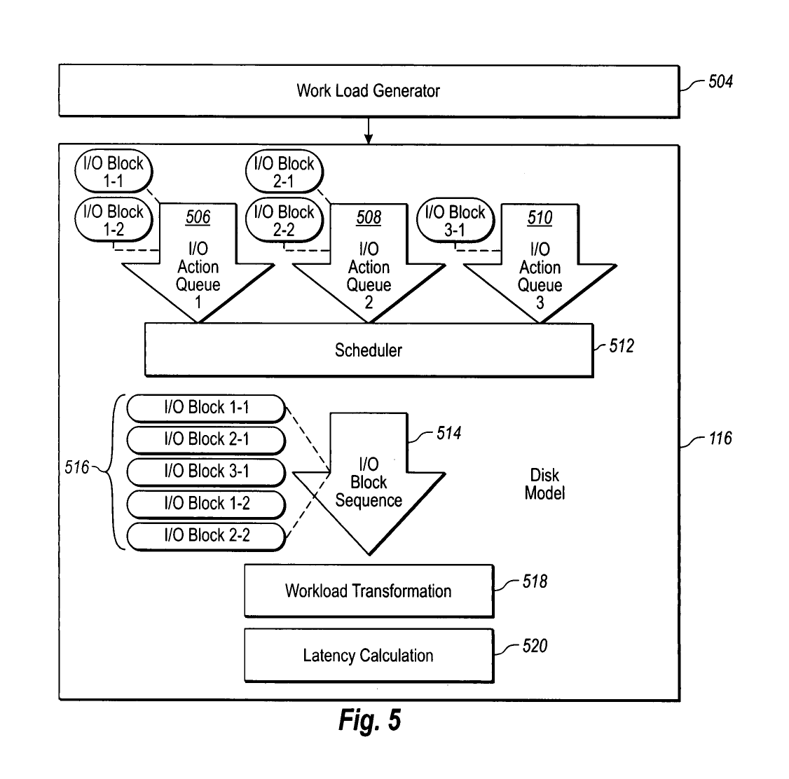

Referring to FIG. 5 an example of a disk model 116 is illustrated In this example, the disk model 116 is the storage model for a single disk drive. The disk model 116 is connected to a workload generator 504. The workload generator may generate various models of I/O operations (sometimes now referred to as I/O actions) that will be directed to the disk model 116. Notably, the I/O actions may be the result of different disjoint activities that take place in the device model 402 (FIG. 4). The disk model 116 generates one event for each I/O block in the I/O action. The number of blocks corresponding to a single action is determined by the I/O total size and I/O block size of the action. Thus, in the disk model 116, events corresponding to I/O blocks of a single I/O action are placed into a single I/O action queue such as I/O action queue 1 506, I/O action queue 2 508, or I/O action queue 3 510. The I/O action queues are connected to a scheduler 512. The scheduler 512 schedules the events corresponding to the I/O blocks in I/O actions queues onto the storage device modeled by the disk model 116. The action queue is persisted until all events in the queue are scheduled for evaluation by the disk model. Each queue maintains a count of its total de-queued bytes.

The scheduler de-queues events from the same action queue until the total number of bytes de-queued exceeds a configurable threshold. This threshold can be configured according to the disk interface type. For example, the threshold for SCSI interfaces could be 63 KB and the threshold for ATA interfaces could be 128 KB. When the de-queued byte threshold is exceeded, the scheduler selects the next action queue by round robin and begins de-queuing events as before. This scheduling policy models I/O interleaving which enables different actions to share the same disk resource without waiting for completion of any single action. For example, large I/O actions does not block the completion of small I/O actions.

FIG. 5 further illustrates an operation transformation 518. Notably, to correctly model the characteristics of real-world device operations, one type of device operation may need to be transformed into another type of device operation depending on a preceding device operation that was performed or on other factors. For example, if two large sequential operations are sent to the disk model 116 the I/O operations may be modeled in the storage device operations queue 514 as interleaved sequential device operations. As such, the second sequential device operation performed is transformed into a random device operation because of the on movement of the disk surface and disk head that will need to take place to perform the second device operation even though the second device operation is a sequential operation. The following table illustrates various operation transformations that may take place at the operation transformation 518.

| | I/O block of | Action of | Subservice of | |
|---|---|---|---|---|
| | current I/O | current device | current I/O | |
| | operation = | operation = | Operation = | I/O pattern |
| I/O pattern | first I/O | action of | Subservice | of current |
| of I/O | block of I/O | last device | of last I/O | device |
| operation | operation | operation | Operation | operation |
| Random | True | — | — | Random |
| Random | False | False | — | Random |
| Random | False | True | — | Sequential |
| Sequential | — | — | True | Sequential |
| Sequential | — | — | False | Random |

FIG. 5 further illustrates that the disk model 116 includes a latency calculation 520. To calculate the latency of a particular device operation, various factors can be taken into account including device operations that need to be processed before the device operation, overhead latency such as those incurred due to the controller or other hardware associated with the disk model 116, as well as time spent in the queue and the empirical modeling at the root of the disk model 116. As discussed previously herein the constant and slope will be taken into account to determine the latency of executing the I/O. Any time spent in the queue is added to the latency separately. For example, for a random read device operation of 100 kilobytes, where the latency response for random reads is 4.1 milliseconds+2.7E-2 milliseconds/kilobyte*IoBlockSize, then the latency calculated is 4.1 milliseconds+2.7E-2 milliseconds/kilobytes*100 KB=5.8 milliseconds. If the queue time is 4.5 milliseconds, then the total latency calculated by the disk model 116 is 5.8 milliseconds+4.5 milliseconds=10.3 milliseconds.

Returning once again to the description of FIG. 1, it will be noted that a disk model 116 may be included in a disk group model 106, which may be included in a disk array model 108. The example shown in FIG. 5 illustrates a single disk model 116 where the disk model 116 includes the constants and slopes for latency calculations. Action queues can introduce additional latencies which can be calculated as part of the simulation of the disk model 116. Queuing delays in the disk model 116 are given by the additional latencies introduced by the action queues. The disk array model 108 when simulated will calculate latency due to inclusion of the disk model 116, disk array controller 110 which may introduce latencies, and a cache model 112 which may help to eliminate latencies by eliminating the need to perform the simulation of the disk model 116.

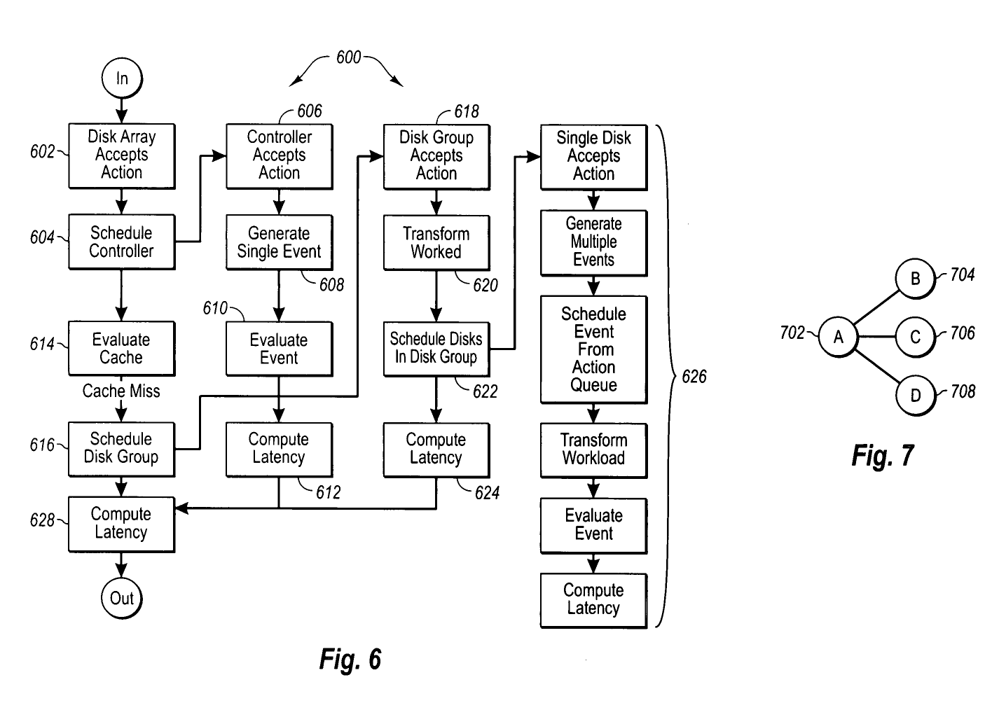

Referring now to FIG. 6 a flow diagram 600 is illustrated which shows the operation of a disk array model 108 (FIG. 1). FIG. 6 illustrates at 602 that the disk array accepts an I/O operation. For example, as shown in FIG. 5, a workload generator 504 may direct models of I/O operations to a disk array model 108 shown in FIG. 1. Returning once again to FIG. 6, at 604, the disk array model schedules a controller such as the disk array controller model 110 shown in FIG. 1. At 606 the controller accepts an action. At 608 a single event is generated to model the actions performed the disk array controller model. At 610 the event is evaluated to calculate the time to live for the event generated at 608. The event time-to-live may be a function of the controller I/O channel capacity, byte size of the I/O, and number of concurrently executing events. The event time to live may be updated iteratively to account for protracted processing time due to resource sharing of the same I/O channel by other concurrently executing events.

At 612 a latency is computed for the event modeled by the disk array controller model. Thus, a latency component for the controller model is calculated for the disk array model.

At 614 a cache model is evaluated to determine if a modeled I/O operation can be serviced from a cache instead of from disk models. The disk array model 108 (FIG. 1) provides a parameterization of cache effectiveness for disk reads. One feature of this parameterization is a mapping of storage utilization and cache size to cache hit probability. If the cache is hit for a disk read, then further scheduling on inner devices does not occur unless the disk array model is called as part of simulation preconditioning. Simulation preconditioning is a modeling technique that considers workload aggregations as part of estimating device utilization. In such cases, the action representing aggregate workload for read operations is still scheduled onto inner devices, but the amplitude of this aggregate workload is reduced in proportion to the cache hit ratio. That is, if the aggregate rate of read actions received by the array model is lambda and the cache hit ratio is alpha, then the aggregate workload scheduled onto a disk group configuration becomes alpha*lambda The disk array model also provides a parameterization of cache effectiveness for disk writes. One feature of this parameterization is a workload transformation based on controller utilization.

If the data is not modeled as being served from cache then the flow diagram 600 illustrates that a disk group is scheduled at 616. The disk group configuration is selected according its-subservice and the subservice associated with the I/O action. If the same subservice is mapped to more than one disk group in the array, then the disk group is selected according to the scheduling policy of the array. The scheduling policies may include for example round robin and load balancing based on disk group utilization.

At 618 the disk group accepts the I/O action. At 620 the workload represented by the I/O action is transformed. For example, if the disk group represents a RAID array, the I/O action will be transformed according to the RAID level and stripe unit size of the disk group. To illustrate workload transformation, consider a single disk write I/O action received by a disk group configured with RAID level 10. First, the workload request is transformed into two write workload requests to model data mirroring. Next, each of these workload requests are further transformed into multiple workload requests in order to model data striping.

At 622, scheduling is performed in the disk group model. Multiple workload requests associated with the same disk I/O action can be independently scheduled onto single disk configurations contained in the disk group model. The disk model for each disk configuration receives the action and transformed workload request. Disk model simulation is illustrated at 626 in FIG. 6, and with more specificity in FIG. 5. The scheduling policies available to the disk group model include for example, round robin and load balancing based on disk queue depth or disk utilization.

At 624, the latency for the disk group model is calculated. The action latency in the disk group model includes the sum of the maximum action latency for a single disk and any additional latency not attributable to the inner disks. For example, FIG. 7 illustrates latencies where latency A 702 is additional latency not attributable to the inner disks, latency B 704 is a latency attributable to a first disk model in the disk group model, latency C 706 is a latency attributable to a second disk in the disk group model, and latency D 708 is a latency attributable to a third disk in the disk group model. The latency calculated at 624 is the addition of latency A 702 plus the longest of latency 704, 706, and 708. This is because the disk models associated with latencies 704, 706, and 708 are simulated in parallel such that only the one with the longest latency contributes to the overall latency of the disk group calculated at 624.

At 628, an overall latency for the disk array is calculated. The latency for the disk array is the sum of the latency for the controller (calculated at 612) and disk group (calculated at 618) and any additional latency not attributable to the controller bandwidth or disk group model. For example the latency for the disk array calculated may include other parameters specified in the disk array model 108.

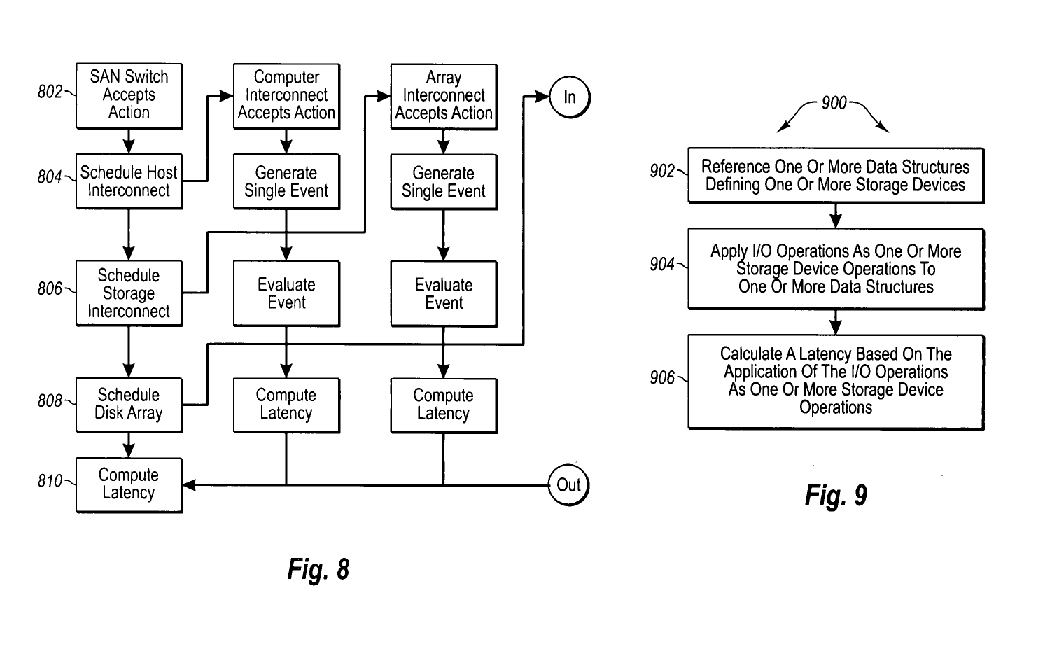

Referring now to FIG. 8, an example is illustrated where a SAN model, such as the SAN model 102 shown in FIG. 1 is simulated. At 802, the SAN model 102 (FIG. 1) accepts an I/O action. The SAN model 102 (FIG. 1) submits the I/O action to the host interconnect model 104 (FIG. 1) at 804, the storage interconnect model 106 (FIG. 1) at 806, and the disk array model 108 (FIG. 1) at 808.

In this example, the interconnect models 104 and 106 support full duplex communication, such as for example Fibre Channel, by allocating a read descriptor and a write descriptor for each interconnect configuration. In general, a device descriptor is a modeling resource that accepts a particular type of device action. For example read descriptors only process disk read actions and write descriptors only process disk write actions. If multiple interconnects are deployed between the same endpoints, then the I/O action is scheduled according to the policy selected by the model. Examples of scheduling policies include round robin and load balancing based on interconnect utilization.

The disk array model 108 (FIG. 1) is selected according the subservice mapping of inner disk groups and the subservice associated with the action. If the same subservice is mapped to more than one disk array model 108 (FIG. 1) connected to a SAN switch model, then the disk array model 109 (FIG. 1) is selected according to the scheduling policy of the disk array model 108 (FIG. 1). The scheduling policies available to the disk array model 108 include for example, round robin.

The SAN model 102 manages calculation of the total latency of the I/O action in the SAN as shown at 810. The action latency attributed to the interconnect models 104 and 106 is the maximum latency due to the host interconnect 104 and array interconnect 106. The total action latency is the sum of the maximum interconnect latency and disk array latency, calculated at 628 in FIG. 6.

Referring now to FIG. 9, a method 900 is illustrated. The method 900 may be practiced for example, in a computing system configured to simulate interactions with one or more storage devices. The method includes acts for simulating a storage device to obtain latencies. The method includes referencing one or more data structures defining one or more storage devices (act 902). Definitions of one or more storage devices may include empirical characterizations of storage device operations for the specific storage devices. For example, the empirical characterization may have been obtained as a result of laboratory testing of one or more sample components of the specific storage devices, or storage device similar to the specific storage devices. For example, as shown in FIG. 2, various I/O operations may be performed to obtain performance characteristics for a storage device such as an individual hard disk drive. Definitions of one or more storage devices may include analytical characterizations. Further, definitions of one or more storage devices may include hybrids of empirical and analytical characterizations.

The method 900 further includes applying models of I/O operations as storage device operations to the one or more data structures (act 904). For example, FIG. 5 illustrates a workload generator 504 the produces models of I/O operations that are applied to a disk model 116 as device operations.

Notably, as shown in FIG. 4 and discussed above applying models of I/O operations as storage device operations to the one or more data structures may include applying the device operations to a storage device model defined by a subservice mapping. Subservice mapping allows models of I/O operations to be applied to a particular storage model by correlating certain types of models of I/O operations with certain storage models.

The method 900 further includes calculating a latency based on the application of the models of I/O operations as storage device operations (act 906). As discussed previously, calculating a latency may include adding latencies obtained by simulation of two or more device operations. For example, if device operations occur one after the other, the latency can be calculated by adding the device operations.

Calculating latencies may include adding a latency defined in one of the data structures defining a latency for at least one of a controller or an interconnect. For example, FIG. 1 illustrates a host interconnect model 104, a storage interconnect model 106 and a disk array controller model 110. Each of these models may include defined latencies that may be included in a calculated latency.

Calculating a latency may include comparing latencies obtained by simulation of two or more device operations and selecting the longest latency as the calculated latency. An example of this is shown at FIG. 7 and discussed in more detail above. In particular, operations may be performed in parallel. As such, the overall latency is dependent on the longest latency of the parallel latencies.

The method 900 may further include dividing the models of I/O operations into smaller operations and scheduling each smaller operation to be applied to the one or more data structures defining a storage device. For example, dividing the models of I/O operations into smaller operations may include dividing a large models of I/O operation into smaller I/O block operations.

The method 900 may further include transforming a device operation to a different device operation. For example, device operations may be transformed based on one or more device operation scheduled to be performed prior to the device operation. For example as illustrated above, a sequential read or write may be transformed into a random read or write. Alternatively, random reads and writes may be transformed into sequential reads and writes.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system configured to simulate interactions with one or more storage devices, a computer readable medium comprising:
a first data structure defining a storage device including an empirical characterization of storage device operations for the specific storage device, the empirical characterization having been obtained as a result of laboratory testing of one or more sample components of the specific storage device, or storage device similar to the specific storage device; and
computer executable instruction configured to simulate application of models of I/O operations as storage device operations to the first data structure and to calculate a latency based on the application of the models of I/O operations as storage device operations.

2. The computer readable medium of claim 1, wherein the first data structure comprises a hierarchical data structure defining a composite storage device, the hierarchical data structure including a plurality of instances of a definition of parameters for a component of the storage device instantiated together.

3. The computer readable medium of claim 2, wherein the definition of parameters defines at least one of parameters of a surface and head when the composite storage device is a disk drive, a disk drive when the composite data structure is a Redundant Array of Independent Disks (RAID) array, or a RAID array when the composite data structure is a Storage Area Network (SAN).

4. The computer readable medium of claim 2, the first data structure further comprising additional properties defining additional characterizations not attributable to the empirical characterization obtained as a result of laboratory testing.

5. The computer readable medium of claim 4, wherein the additional properties define latencies due to at least one of I/O queue, an I/O interconnect or an I/O controller.

6. The computer readable medium of claim 1, wherein the first data structure defines empirical characterization of the storage device performance that can be used in simulation to compute I/O latencies by including one or more constants and slopes for at least one of a random read, a random write, a sequential read and/or a sequential write, the constants and slopes being usable to determine a latency for a specific operation size.

7. The computer readable medium of claim 1, wherein the first data structure comprises an XML document.

8. The computer readable medium of claim 1, wherein the workload operations define models of I/O operations as at least one of a read or write, I/O operations as at least one of random or sequential, the total size of the models of I/O operation, and the block size of the models of I/O operation.

9. In a computing system configured to simulate interactions with one or more storage devices, a computer readable medium comprising:
a first data structure, defining a storage device including an empirical characterization of storage device operations for the specific storage device, the empirical characterization having been obtained as a result of laboratory testing of one or more sample components of the specific storage device, or storage device similar to the specific storage device wherein the first data structure comprises a hierarchical data structure defining a composite storage device, the hierarchical data structure including a plurality of instances of a definition of parameters for a component of the storage device instantiated together.

10. The computer readable medium of claim 9, wherein the instances of a definition of parameters is included as a reference to a second data structure.

11. In a computing system configured to simulate interactions with one or more storage devices, a method of simulating a storage device to obtain latencies, the method comprising:
referencing one or more data structures, the one or more data structures defining one or more storage devices including empirical or analytic or hybrid characterizations of storage device operations for the specific storage devices, the empirical characterization having been obtained as a result of laboratory testing of one or more sample components of the specific storage devices, or storage device similar to the specific storage devices;
simulating the storage device by applying a model of I/O operations as storage device operations to the one or more data structures; and
calculating a latency based on the application of the model of I/O operations as storage device operations.

12. The method of claim 11, further comprising dividing the model of I/O operations into smaller operations and scheduling each smaller operation to be applied to the one or more data structures defining a storage device.

13. The method of claim 12, wherein dividing the model of I/O operations into smaller operations comprises dividing a large model of I/O operation into smaller I/O block operations.

14. The method of claim 11, wherein calculating a latency comprises at least one of adding latencies obtained by simulation of two or more device operations, comparing latencies obtained by simulation of two or more device operations and selecting the longest latency as at least a part of the calculated latency or applying other mathematical function to latencies obtained by simulation of two or more device operations.

15. The method of claim 11, further comprising transforming a device operation to a different device operation possibly using the original device operation as input for determining the resulting device operation.

16. The method of claim 15, wherein transforming a device operation into a different device operation comprises transforming the device operation based on at least one of one or more device operations scheduled to be performed prior to the device operation or RAID logic in a disk group model.

17. The method of claim 15, wherein transforming a device operation to a different device operation comprises at least one of transforming a sequential read or write to a random read or write or transforming a random read or write to a sequential read or write.

18. The method of claim 11, wherein calculating latencies comprises:
using a first latency defining latencies of I/O operations of one or more storage devices including characterizations of storage device operations obtained from empirical testing;
combining with the first latency latency due to at least one of I/O queuing model, I/O interconnect model, or I/O controller model, or other resource sharing model.

19. The method of claim 11, wherein applying model of I/O operations as storage device operations to the one or more data structures comprises applying the device operations to a storage device model defined by a subservice mapping.
